(19) United States
(12) Patent Application Publication
(10) Pub. No.: US 2026/0108858 A1
(43) Pub. Date: Apr. 23, 2026

(54) PROCESSES AND APPARATUSES FOR CONTROLLING A TEMPERATURE OF A REACTOR

(71) Applicant: UOP LLC, Des Plaines, IL (US)

(72) Inventors: Rodrigo J. Lobo, Des Plaines, IL (US); Moataz Sheha, Glenview, IL (US); Erick J. Bennett, III, New Lenox, IL (US); Suryanarayana Murthy Konda Naga Venkata, Des Plaines, IL (US); Shubhra J. Bhadra, Naperville, IL (US); Rajasi Shukre, Bloomingdale, IL (US)

(21) Appl. No.: 18/924,805

(22) Filed: Oct. 23, 2024

(51) Int. Cl. B01J 8/04; C01B 5/00

(52) U.S. Cl. CPC B01J 8/0469; C01B 5/00; B01J 2208/00017

(57) ABSTRACT

Processes and apparatuses for controlling a temperature of a reactor. Oxygen and hydrogen are reacted in a reactor which contains a catalyst configured to catalyze a reaction between oxygen and hydrogen and produce an effluent comprising water. Water is removed from the effluent in a separation zone having a plurality of vessels containing an adsorbent configured to adsorb water and provide a purified product stream, the purified product stream comprises oxygen or hydrogen. An exotherm of the reactor is controlled by recycling a recycled stream which comprises a portion of the effluent stream or a portion of the purified product stream.

### FIELD OF THE INVENTION

This invention relates generally to processes and apparatuses for controlling a temperature in a reaction zone, and more particular to controlling the temperature in a reaction zone which reacts, in the presence of a catalyst, oxygen and hydrogen together.

### BACKGROUND OF THE INVENTION

The production of hydrogen using water electrolysis is a market which is attracting attention, and which is expected to grow significantly in the coming decade. However, the hydrogen produced by a water electrolyzer also contains a high concentration of oxygen (100 to 5,000 ppm or even 20,000 ppm) and water (1,000 to 20,000 ppm). Unfortunately, many applications in which the produced hydrogen is intended to be utilized are not able to tolerate such levels of oxygen or water. For example, a hydrogen fuel cell requires <5 ppm oxygen. Thus, oxygen removal and dehydration are required before the hydrogen can be utilized in many applications.

The removal of oxygen is typically accomplished by reacting, with a catalyst, oxygen with hydrogen from the same stream. This reaction is a highly exothermic reaction. Additionally, the output of an electrolyzer is directly dependent on the source of electricity. If, for example, green electricity is used, it is known that green electricity availability can vary, which can result in large fluctuations on the reaction requirements. During a reaction turndown, the concentration of oxygen often increases (despite the lower flowrates).

As the flow from the electrolyzer decreases (and the oxygen concentration increases), the exit temperature of the conversion reactor increases. Although not being bound by any particular theory, this increased temperature is believed to have a negative impact on the catalyst life, lead to higher capital costs, and may pose a safety risk.

Accordingly, it would be desirable to have more effective and efficient ways to address oxygen removal and, specifically, the exotherm related to relatively high oxygen concentrations, as well as the addressing the need for dehydration, from hydrogen streams.

### SUMMARY OF THE INVENTION

The present inventors have invented processes and apparatus that mitigate the exotherm of the reaction by re-routing or recycling an oxygen depleted or oxygen free stream from elsewhere in the process to upstream the location where oxygen reacts with hydrogen.

Therefore, the present invention may be characterized, in at least one aspect, as providing a process for controlling a temperature of a reactor by: reacting oxygen and hydrogen from a feed stream in a reaction zone comprising a reactor, the reactor containing a catalyst configured to catalyze a reaction between oxygen and hydrogen and configured to produce an effluent comprising water; removing water from the effluent in a separation zone, the separation zone comprising a plurality of vessels containing an adsorbent configured to adsorb water and provide a purified product stream, the purified product stream comprising oxygen or hydrogen; and reducing an exotherm of the reactor with a recycled stream, wherein the recycled stream comprises a portion of the effluent stream or a portion of the purified product stream.

The process may further include regenerating the adsorbent in the separation zone with a portion of the purified product stream to provide a regeneration gas, wherein the regeneration gas comprises the recycled stream.

The process may further include cooling the effluent stream in a water removal zone to provide a water depleted effluent stream, wherein a portion of the water depleted effluent stream comprises the recycled stream. The recycled stream may be a portion of the effluent stream that is separated from the effluent stream upstream of the water removal zone.

The separation zone comprises a TSA separation zone or the separation zone comprises a PSA separation zone.

The process may further include removing water from the feed stream in a pretreatment zone upstream of the reaction zone. The pretreatment zone may include a vessel containing an adsorbent configured to adsorb water and provide a water depleted feed stream, and the pretreatment zone and the separation zone may have a combined cooler.

The process may further include removing water from the feed stream in a pretreatment zone upstream of the reaction zone. The pretreatment zone may include at least one vessel containing an adsorbent configured to adsorb water and provide a water depleted feed stream. The at least one vessel of the pretreatment zone and a vessel the separation zone may be operated in a lead lag cycle.

The purified product stream may be a purified hydrogen stream or a purified oxygen stream.

In a second aspect, the present invention may generally be characterized as providing a process for controlling a temperature of a reactor by: passing a feed stream comprising oxygen and hydrogen to a reaction zone comprising a reactor, the reactor containing a catalyst configured to catalyze a reaction between oxygen and hydrogen and configured to produce an effluent stream comprising water; passing the effluent stream to a separation zone, the separation zone comprising a plurality of vessels containing an adsorbent configured to adsorb water, the separation zone configured to provide a purified product stream, the purified product stream comprising oxygen or hydrogen; and passing a recycled stream to the reactor to reduce an exotherm of the reactor, wherein the recycled stream comprises a portion of the effluent stream or a portion of the purified product stream.

The separation zone may include a TSA separation zone, a PSA separation zone, or a combination thereof.

The purified product stream may be a purified hydrogen stream or a purified oxygen stream.

The process may further include regenerating the adsorbent in the separation zone with a portion of the purified product stream to provide a regeneration gas, and passing the regeneration gas to the reactor as the recycled stream.

The process may further include passing the effluent stream to a water removal zone disposed upstream of the separation zone and cooling the effluent stream in the water removal zone to separate water and provide a water depleted effluent stream, passing a first portion of the water depleted effluent stream to the reactor as the recycled stream, and, passing a second portion of the water depleted effluent stream to the separation zone.

The process may further include passing a first portion of the effluent stream to a water removal zone disposed upstream of the separation zone and cooling the effluent stream in the water removal zone to separate water and provide a water depleted effluent stream, passing a second portion of the effluent stream to the reactor as the recycled stream; and, passing the water depleted effluent stream to the separation zone.

The process may further include passing the feed stream to a pretreatment zone, the pretreatment zone upstream of the reaction zone, wherein the pretreatment zone comprises a vessel containing an adsorbent configured to adsorb water and provide a water depleted feed stream. The pretreatment zone and the separation zone may have a combined cooler.

The process may further include passing the feed stream to a pretreatment zone, the pretreatment zone upstream of the reaction zone. The pretreatment zone comprises at least one vessel containing an adsorbent configured to adsorb water and provide a water depleted feed stream. The at least one vessel of the pretreatment zone and a vessel the separation zone may be operated in a lead lag cycle.

In a third aspect, the present invention may be characterized as providing an apparatus having: a reaction zone comprising a reactor, the reactor containing a catalyst configured to catalyze a reaction between oxygen and hydrogen and configured to produce an effluent stream comprising water; a separation zone, the separation zone comprising a plurality of vessels containing an adsorbent configured to adsorb water, the separation zone configured to provide a purified product stream, the purified product stream comprising oxygen or hydrogen; and a line configured to pass a recycled stream to the reactor to reduce an exotherm of the reactor, wherein the recycled stream comprises a portion of the effluent stream or a portion of the purified product stream.

The apparatus may further include a water removal zone disposed upstream of the separation zone and configured to cool the effluent stream in the water removal zone to separate water and provide a water depleted effluent stream.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

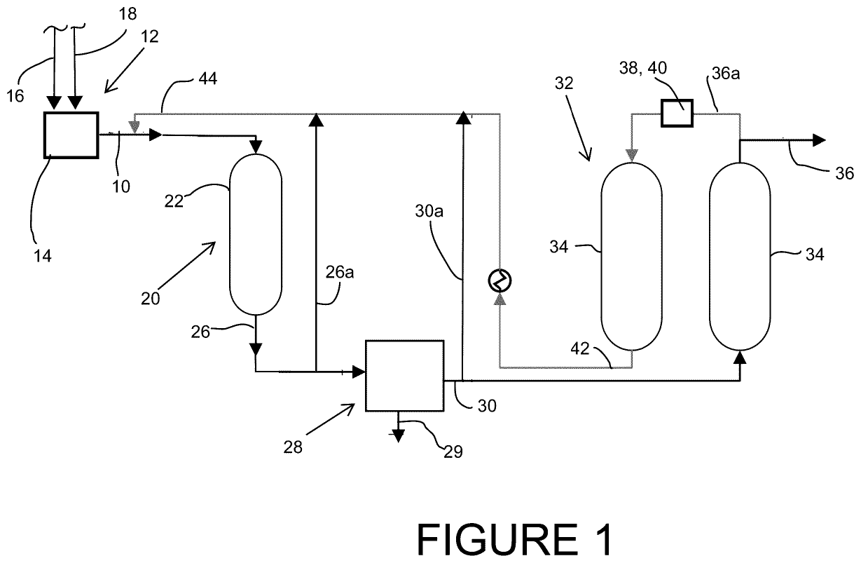

FIG. 1 shows a process flow diagram of a process according to one or more embodiments of the present invention;

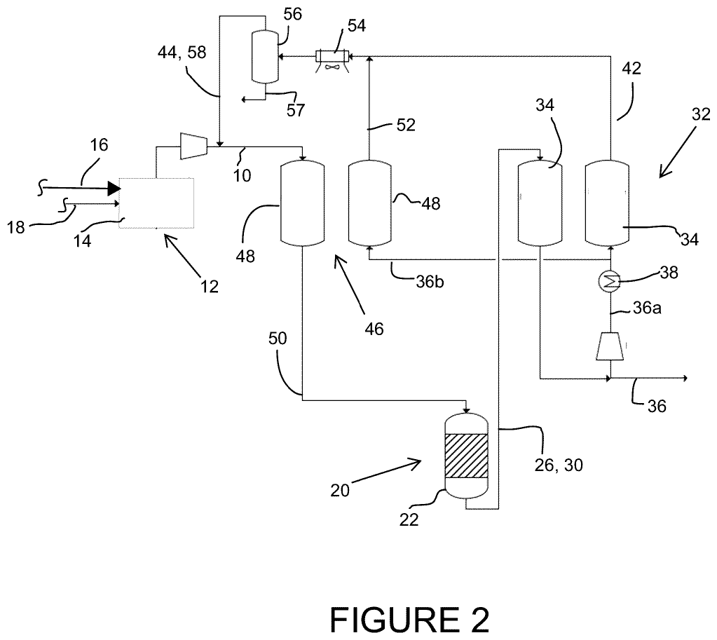

FIG. 2 shows another process flow diagram of a process according to one or more embodiments of the present invention;

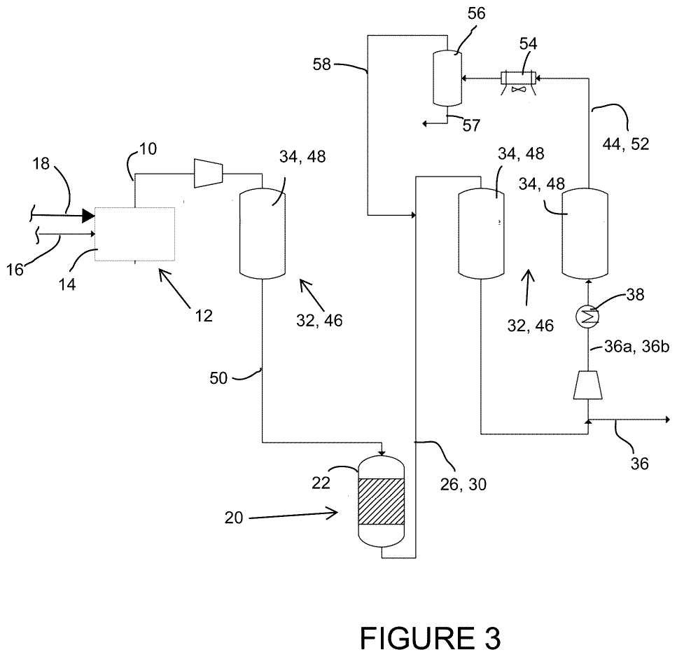

FIG. 3 shows a further process flow diagram of a process according to one or more embodiments of the present invention.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention. In general, the same reference numbers will be used throughout the drawing(s) and accompanying written description to refer to the same or like parts.

### DETAILED DESCRIPTION OF THE INVENTION

As mentioned above, processes and apparatuses for removing oxygen and water from a hydrogen effluent have been invented. The processes and apparatuses may be used to provide a high purity hydrogen stream or may be used to provide a high purity oxygen stream. Additionally, the present processes and apparatuses increase the hydrogen recovery of the overall separation process.

In general, in the various embodiments, first, a deoxygenation reactor is utilized for reacting oxygen with hydrogen in the presence of a catalyst to produce a stream depleted in oxygen. This portion of the process includes the reactor and equipment required to adjust the temperature of the streams entering and exiting the reactor.

A water separation zone including a cooler and a vessel may be utilized for bulk removal of free water. The effluent may be cooled to a desired temperature and condensed water is removed in the water separation zone.

In a third section, the remaining water is removed using an adsorption system in which the water containing oxygen depleted stream is dehydrated in a system with two or more adsorbent beds that allow continuous dehydration of the stream while allowing fully saturated beds to be regenerated. Regeneration of the beds is accomplished by flowing a regeneration gas, typically hydrogen from the process stream (either before or after dehydration) to raise the temperature of the adsorbent and sweep away the water. Then the water is recovered after the spent regeneration stream is cooled and water is condensed.

To reduce any exotherm problems in the oxygen conversion reactor, for example those associated with an increased oxygen concentrations (for example, from reduced electrolyzer output), one of the streams downstream of the oxygen conversion reactor is recycled upstream of the conversion reactor to sufficiently reduce the concentration of oxygen in the reactor such that the exotherm would not negatively impact the performance. It is contemplated that the regeneration gas stream, downstream of the adsorbent bed under regeneration (and after condensed water removal), is combined with the feed stream upstream of the reactor as the recycled stream. Alternatively, a portion of the effluent stream from the reactor may be recycled, taken either before or after bulk water removal.

With these general principles in mind, one or more embodiments of the present invention will be described with the understanding that the following description is not intended to be limiting.

Turning to FIG. 1, a hydrogen stream 10 is provided from a reaction zone 12. In an exemplary embodiment, the reaction zone 12 comprises an electrolyzer 14. As is known, the electrolyzer 14 receives water 16 and electricity 18 and produces an effluent that includes hydrogen, oxygen, and water and thus may be utilized to form the hydrogen stream 10 processed according to the present invention. Although not depicted as such, a separate oxygen stream may also provided from the reaction zone 12. As will be discussed below, an electrolyzer is merely exemplary of the reaction zone 12, and the hydrogen stream 10 may be a stream produced from another type of reaction zone 12 and may include other components.

The hydrogen stream 10, as a feed stream, is passed to a reaction zone 20 that includes one or more reactors 22. Each reactor 22 contains a bed with a catalyst that is configured to react hydrogen and oxygen and produce an effluent that includes water, and further includes hydrogen, and that may include trace amounts of oxygen (<10 ppm or <20 ppm). The catalyst and operating conditions of such a reactor 22 are known in the art and the details of which are not needed for an understanding or practicing of this invention. One more heat exchangers (not shown) may be used within the reaction zone 20 to further assist in controlling a temperature of the reactor 22 in the reaction zone 20.

An effluent stream 26 from the reaction zone 20 may be cooled and passed to a water removal zone 28 where water 29 condenses out of the effluent stream 26 to provide a water depleted effluent stream 30. The water removal zone 28 is optional and may or may not be utilized. The water depleted effluent stream 30 (or the effluent stream 26 if no water removal zone 28 is provided) is passed to a separation zone 32.

The separation zone 32 includes a plurality of vessels 34 each containing a bed of an adsorbent configured to selectively adsorb water. The separation zone 32 thus provides a purified product stream 36. This purified product stream 36 may be a hydrogen stream, or in some instances may be an oxygen stream.

Suitable materials for the adsorbent include zeolite based (A-type zeolite or X-type zeolite) adsorbents and silica gels, to name a few.

In order to regenerate the adsorbent in the vessels 34 of the separation zone 32, a portion 36a of the purified product stream 36 is utilized. If operating the separation zone 32 as a temperature swing adsorption zone, a heater 38 may be utilized to heat the portion 36a of the purified product stream 36 for regeneration. A compressor may also be utilized with the temperature swing adsorption zone. If operating the separation zone 32 as a pressure swing adsorption zone, a compressor 40 may be used to compress the portion 36a of the purified product stream 36 utilized for regeneration. A spent regeneration gas 42 is typically combined with the water depleted effluent stream 30 (or the effluent stream 26 if no water removal zone 28 is provided) and returned to the separation zone 32.

As discussed above, the reaction between oxygen and hydrogen in the reaction zone 20 is exothermic and the exotherm of the reactor 22 will increase with increase oxygen. Accordingly, the present invention seeks to control the temperature of the reactor 22 with a recycle stream 44 that is low in oxygen.

In one embodiment, the recycle stream 44 may be a portion of the purified product stream 36. In particular, it is contemplated that the spent regeneration gas 42 (which is portion 36a of the purified product stream 36) may be recycled to the reaction zone 20 to control the reactor exotherm as the recycle stream 44.

It is also contemplated that a portion 26a of the effluent stream 26 from the reaction zone 20 is utilized as the recycle stream 44 to control the reactor exotherm. If the water removal zone 28 is provided, a portion 30a of the water depleted effluent stream 30 may be used. Alternatively, even with the water removal zone 28, a portion 26a of the effluent stream 26 may be taken upstream of the water removal zone 28 and used to control the reactor exotherm as the recycle stream 44.

With a recycle stream 44 that is low in oxygen, the present processes and apparatuses provide for temperature control of the reactor 22 in which hydrogen and oxygen are being reacted.

As noted above, the hydrogen stream 10 from the reaction zone 12 will include water. Inside the reactor 22 of reaction zone 20, there is a possibility of water droplets forming on the catalyst. A superheater may be utilized to avoid condensation and would be suitable if the catalyst requires a higher temperature to perform the reaction. In such a case, the superheater would both preheat the stream and move it above its dew point to protect the catalyst. However, in the event the catalyst is moisture sensitive and requires water to be removed from the hydrogen stream and/or the catalyst does not require a significantly higher temperature than the reaction zone outlet temperature, a superheater may not be suitable.

Accordingly, as shown in FIGS. 2 and 3, a pretreatment zone 46 is provided to remove water from the hydrogen stream 10 before it is passed to the reaction zone 20. The pretreatment zone 46 includes one or more vessels 48 containing an adsorbent configured to adsorb water and provide a water depleted hydrogen 50, or feed, stream. In particular, the vessels 48 of the pretreatment zone 46 may be similar to the vessels 34 of the separation zone 32 and may contain the same adsorbent. It should be appreciated, that the vessels 48 of the pretreatment zone 46 and the vessels 34 of the separation zone 32 may be interchangeable, with the same vessel, 34, 48 being in the separation zone 32 at some point in the process, and the in the pretreatment zone 46 in another point in the process.

Accordingly, to reduce equipment, the vessels 34, 48 of the separation zone 32 and the pretreatment zone 46 may utilize combined processing equipment.

For example, a portion 36b of the purified product stream 36 may also be used to regenerate adsorbent in a vessel 48 of the pretreatment zone 46. The spent regeneration gas 42 from the separation zone 32 and a spent regeneration gas 52 from the pretreatment zone 46 may be combined and cooled in a combined cooler 54 and passed to a combined knockout vessel 56 to remove water 57. A vapor stream 58 from the knockout drum may compressed and combined with the feed stream 10. Due to the use of the regeneration gas 42 from the separation zone 32, the vapor stream 58 will act to control the temperature of the reactor as recycle stream 44. Thus, each zone 32, 46 does not require its own cooler 54 and knockout vessel 56 for liquid-gas separation.

As shown in FIG. 3, it is also contemplated that the vessels 34, 48 of the separation zone 32 and the pretreatment zone 46 are operated in a lead/lag cycle. In the depicted configuration, which is merely exemplary, a vessel 34, 48 in the lag configuration is in the separation zone 32 and a vessel 34, 48 in the lead configuration is in the pretreatment zone 46. The order that the vessels 34, 48 are in lead and lag may be adjusted to align for the best possible sequence. Determining which vessel 34, 48 is the lead and which is the lag while optimizing the recycle location can ensure minimum oxygen slippage into the product stream 36 as the swing cycle progresses through its sequence. Although not depicted as such, a portion of streams 58 26, 30, 50 may be combined with the feed stream 10 as the recycle stream 44 to control the temperature of the reactor 22 in the reaction zone 20.

Returning to FIG. 1, depending on the production method a variety of contaminants may be present in the hydrogen stream 10, including nitrogen, oxygen, water, hydrocarbons, to name a few. In many applications for the produced hydrogen, these contaminants cannot be tolerated and hence their removal is required.

The most widespread method of hydrogen purification is pressure swing adsorption (PSA). Where impurities are captured at high pressure and released at low pressure in the “tailgas”. The mark of an efficient PSA process is one in which the hydrogen in the tailgas is minimized, by both reducing its concentration, and total tail gas flow. This aspect of the efficiency is represented in terms of a single pass recovery of hydrogen into the hydrogen product.

Although PSA is highly efficient in the removal of impurities such as nitrogen, hydrocarbons, carbon monoxide and carbon dioxide, other contaminants such as oxygen can pose significant difficulties. Accordingly, the adsorbent in the separation zone 32 may include multiple adsorbents. For example, one or more beds in each vessel 34 may be configured to adsorb oxygen. Each vessel 34 could have additional beds with adsorbent configured to adsorb nitrogen, hydrocarbons, carbon monoxide, and/or carbon dioxide. To desorb the nitrogen, hydrocarbons, carbon monoxide and carbon dioxide, the separation zone 32 could be operated as a pressure swing adsorption zone. To desorb oxygen, the separation zone 32 could be operated as a temperature swing adsorption zone. The ability to remove multiple contaminants provides the present processes and apparatuses with flexibility for processing.

### EXPERIMENTS

A computer simulation was used for three examples and the reactor exotherm was determined. Various temperatures from the simulation are shown below in TABLE 1.

In example 1 (a comparative example), a feed gas (including hydrogen and oxygen) was introduced to the process and enters the reactor without being mixed with any other stream. The reactor was adiabatic.

In example 2, the feed gas (including hydrogen and oxygen) was mixed with a stream with trace oxygen concentration prior to entering the reactor. The reactor was adiabatic. The recycle flow amounted 20% of the flow of the process design flow and was unchanged as the feed rate was reduced.

TABLE 1, below, shows a resulting reactor exotherm when the recycle stream is not present (example 1) and included and mixed with the feed stream (example 2). As shown in TABLE 1, the feed was the hydrogen stream that contains oxygen at different concentrations, and was water saturated. The oxygen concentration was 2000 ppm at the design flow and, the amount of oxygen entering the process remained unchanged regardless of flow. As the flow to the process was reduced the oxygen concentration entering the reactor increased, and so did the exotherm. Thus, it is believed that a low oxygen, or no oxygen, containing recycle stream would lower the reactor exotherm.

TABLE 1

| | | |
|---|---|---|
| Flow in | | Exotherm in the |
| stream 10 | O2 concen- | reactor (° C.) |

| relative to | tration at | Example 1 - | Example 2 - |
|---|---|---|---|
| design flow | process inlet | Recycle | Recycle |
| (%) | (ppmv) | Not Present | Present |
| 100 | 2000 | 34 | 28 |
| 75 | 2667 | 44 | 35 |
| 50 | 4000 | 67 | 48 |
| 30 | 6667 | 112 | 67 |
| 20 | 10000 | 168 | 83 |

### SPECIFIC EMBODIMENTS

While the following is described in conjunction with specific embodiments, it will be understood that this description is intended to illustrate and not limit the scope of the preceding description and the appended claims.

A first embodiment of the invention is a process for controlling a temperature of a reactor, the process comprising reacting oxygen and hydrogen from a feed stream in a reaction zone comprising a reactor, the reactor containing a catalyst configured to catalyze a reaction between oxygen and hydrogen and configured to produce an effluent comprising water; removing water from the effluent in a separation zone, the separation zone comprising a plurality of vessels containing an adsorbent configured to adsorb water and provide a purified product stream, the purified product stream comprising oxygen or hydrogen; and reducing an exotherm of the reactor with a recycled stream, wherein the recycled stream comprises a portion of the effluent stream or a portion of the purified product stream. An embodiment of the invention is one, any or all of prior embodiments in this paragraph up through the first embodiment in this paragraph, further comprising regenerating the adsorbent in the separation zone with a portion of the purified product stream to provide a regeneration gas, wherein the regeneration gas comprises the recycled stream. An embodiment of the invention is one, any or all of prior embodiments in this paragraph up through the first embodiment in this paragraph, further comprising cooling the effluent stream in a water removal zone to provide a water depleted effluent stream, wherein a portion of the water depleted effluent stream comprises the recycled stream. An embodiment of the invention is one, any or all of prior embodiments in this paragraph up through the first embodiment in this paragraph, wherein the recycled stream comprises a portion of the effluent stream separated from the effluent stream upstream of the water removal zone. An embodiment of the invention is one, any or all of prior embodiments in this paragraph up through the first embodiment in this paragraph, wherein the separation zone comprises a TSA separation zone. An embodiment of the invention is one, any or all of prior embodiments in this paragraph up through the first embodiment in this paragraph, wherein the separation zone comprises a PSA separation zone. An embodiment of the invention is one, any or all of prior embodiments in this paragraph up through the first embodiment in this paragraph, further comprising removing water from the feed stream in a pretreatment zone upstream of the reaction zone, wherein the pretreatment zone comprises a vessel containing an adsorbent configured to adsorb water and provide a water depleted feed stream, wherein the pretreatment zone and the separation zone comprise a combined cooler. An embodiment of the invention is one, any or all of prior embodiments in this paragraph up through the first embodiment in this paragraph, further comprising removing water from the feed stream in a pretreatment zone upstream of the reaction zone, wherein the pretreatment zone comprises at least one vessel containing an adsorbent configured to adsorb water and provide a water depleted feed stream, wherein the at least one vessel of the pretreatment zone and a vessel the separation zone are operated in a lead lag cycle. An embodiment of the invention is one, any or all of prior embodiments in this paragraph up through the first embodiment in this paragraph, wherein the purified product stream comprises a purified hydrogen stream. An embodiment of the invention is one, any or all of prior embodiments in this paragraph up through the first embodiment in this paragraph, wherein the purified product stream comprises a purified oxygen stream.

A second embodiment of the invention is a process for controlling a temperature of a reactor, the process comprising passing a feed stream comprising oxygen and hydrogen to a reaction zone comprising a reactor, the reactor containing a catalyst configured to catalyze a reaction between oxygen and hydrogen and configured to produce an effluent stream comprising water; passing the effluent stream to a separation zone, the separation zone comprising a plurality of vessels containing an adsorbent configured to adsorb water, the separation zone configured to provide a purified product stream, the purified product stream comprising oxygen or hydrogen; and passing a recycled stream to the reactor to reduce an exotherm of the reactor, wherein the recycled stream comprises a portion of the effluent stream or a portion of the purified product stream. An embodiment of the invention is one, any or all of prior embodiments in this paragraph up through the second embodiment in this paragraph, wherein the separation zone comprises a TSA separation zone, a PSA separation zone, or a combination thereof. An embodiment of the invention is one, any or all of prior embodiments in this paragraph up through the second embodiment in this paragraph, wherein the purified product stream comprises a purified hydrogen stream or a purified oxygen stream. An embodiment of the invention is one, any or all of prior embodiments in this paragraph up through the second embodiment in this paragraph, further comprising regenerating the adsorbent in the separation zone with a portion of the purified product stream to provide a regeneration gas; and, passing the regeneration gas to the reactor as the recycled stream. An embodiment of the invention is one, any or all of prior embodiments in this paragraph up through the second embodiment in this paragraph, further comprising passing the effluent stream to a water removal zone disposed upstream of the separation zone and cooling the effluent stream in the water removal zone to separate water and provide a water depleted effluent stream; passing a first portion of the water depleted effluent stream to the reactor as the recycled stream; and, passing a second portion of the water depleted effluent stream to the separation zone. An embodiment of the invention is one, any or all of prior embodiments in this paragraph up through the second embodiment in this paragraph, further comprising passing a first portion of the effluent stream to a water removal zone disposed upstream of the separation zone and cooling the effluent stream in the water removal zone to separate water and provide a water depleted effluent stream; passing a second portion of the effluent stream to the reactor as the recycled stream; passing the water depleted effluent stream to the separation zone. An embodiment of the invention is one, any or all of prior embodiments in this paragraph up through the second embodiment in this paragraph, further comprising passing the feed stream to a pretreatment zone, the pretreatment zone upstream of the reaction zone, wherein the pretreatment zone comprises a vessel containing an adsorbent configured to adsorb water and provide a water depleted feed stream, wherein the pretreatment zone and the separation zone comprise a combined cooler. An embodiment of the invention is one, any or all of prior embodiments in this paragraph up through the second embodiment in this paragraph, further comprising passing the feed stream to a pretreatment zone, the pretreatment zone upstream of the reaction zone, wherein the pretreatment zone comprises at least one vessel containing an adsorbent configured to adsorb water and provide a water depleted feed stream, wherein the at least one vessel of the pretreatment zone and a vessel the separation zone are operated in a lead lag cycle.

A third embodiment of the invention is an apparatus comprising a reaction zone comprising a reactor, the reactor containing a catalyst configured to catalyze a reaction between oxygen and hydrogen and configured to produce an effluent stream comprising water; a separation zone, the separation zone comprising a plurality of vessels containing an adsorbent configured to adsorb water, the separation zone configured to provide a purified product stream, the purified product stream comprising oxygen or hydrogen; and a line configured to pass a recycled stream to the reactor to reduce an exotherm of the reactor, wherein the recycled stream comprises a portion of the effluent stream or a portion of the purified product stream. An embodiment of the invention is one, any or all of prior embodiments in this paragraph up through the third embodiment in this paragraph further comprising a water removal zone disposed upstream of the separation zone and configured to cool the effluent stream in the water removal zone to separate water and provide a water depleted effluent stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for controlling a temperature of a reactor, the process comprising:
reacting oxygen and hydrogen from a feed stream in a reaction zone comprising a reactor, the reactor containing a catalyst configured to catalyze a reaction between oxygen and hydrogen and configured to produce an effluent comprising water;
removing water from the effluent in a separation zone, the separation zone comprising a plurality of vessels containing an adsorbent configured to adsorb water and provide a purified product stream, the purified product stream comprising oxygen or hydrogen; and
reducing an exotherm of the reactor with a recycled stream, wherein the recycled stream comprises a portion of the effluent or a portion of the purified product stream.

2. The process of claim 1, further comprising:
regenerating the adsorbent in the separation zone with a portion of the purified product stream to provide a regeneration gas, wherein the regeneration gas comprises the recycled stream.

3. The process of claim 1, further comprising:
cooling the effluent in a water removal zone to provide a water depleted effluent stream, wherein a portion of the water depleted effluent stream comprises the recycled stream.

4. The process of claim 3, wherein the recycled stream comprises a portion of the effluent separated from the effluent stream upstream of the water removal zone.

5. The process of claim 1, wherein the separation zone comprises a TSA separation zone.

6. The process of claim 1, wherein the separation zone comprises a PSA separation zone.

7. The process of claim 1, further comprising:
removing water from the feed stream in a pretreatment zone upstream of the reaction zone, wherein the pretreatment zone comprises a vessel containing an adsorbent configured to adsorb water and provide a water depleted feed stream, wherein the pretreatment zone and the separation zone comprise a combined cooler.

8. The process of claim 1, further comprising:
removing water from the feed stream in a pretreatment zone upstream of the reaction zone, wherein the pretreatment zone comprises at least one vessel containing an adsorbent configured to adsorb water and provide a water depleted feed stream, wherein the at least one vessel of the pretreatment zone and a vessel the separation zone are operated in a lead lag cycle.

9. The process of claim 1, wherein the purified product stream comprises a purified hydrogen stream.

10. The process of claim 1, wherein the purified product stream comprises a purified oxygen stream.

11. A process for controlling a temperature of a reactor, the process comprising:
passing a feed stream comprising oxygen and hydrogen to a reaction zone comprising a reactor, the reactor containing a catalyst configured to catalyze a reaction between oxygen and hydrogen and configured to produce an effluent stream comprising water;
passing the effluent stream to a separation zone, the separation zone comprising a plurality of vessels containing an adsorbent configured to adsorb water, the separation zone configured to provide a purified product stream, the purified product stream comprising oxygen or hydrogen; and
passing a recycled stream to the reactor to reduce an exotherm of the reactor, wherein the recycled stream comprises a portion of the effluent stream or a portion of the purified product stream.

12. The process of claim 11, wherein the separation zone comprises a TSA separation zone, a PSA separation zone, or a combination thereof.

13. The process of claim 11, wherein the purified product stream comprises a purified hydrogen stream or a purified oxygen stream.

14. The process of claim 11, further comprising:
regenerating the adsorbent in the separation zone with a portion of the purified product stream to provide a regeneration gas; and,
passing the regeneration gas to the reactor as the recycled stream.

15. The process of claim 11, further comprising:
passing the effluent stream to a water removal zone disposed upstream of the separation zone and cooling the effluent stream in the water removal zone to separate water and provide a water depleted effluent stream;
passing a first portion of the water depleted effluent stream to the reactor as the recycled stream; and,
passing a second portion of the water depleted effluent stream to the separation zone.

16. The process of claim 11, further comprising:
passing a first portion of the effluent stream to a water removal zone disposed upstream of the separation zone and cooling the effluent stream in the water removal zone to separate water and provide a water depleted effluent stream;
passing a second portion of the effluent stream to the reactor as the recycled stream;
passing the water depleted effluent stream to the separation zone.

17. The process of claim 11, further comprising:
passing the feed stream to a pretreatment zone, the pretreatment zone upstream of the reaction zone, wherein the pretreatment zone comprises a vessel containing an adsorbent configured to adsorb water and provide a water depleted feed stream, wherein the pretreatment zone and the separation zone comprise a combined cooler.

18. The process of claim 11, further comprising:
passing the feed stream to a pretreatment zone, the pretreatment zone upstream of the reaction zone,
wherein the pretreatment zone comprises at least one vessel containing an adsorbent configured to adsorb water and provide a water depleted feed stream, wherein the at least one vessel of the pretreatment zone and a vessel the separation zone are operated in a lead lag cycle.

19. An apparatus comprising:
a reaction zone comprising a reactor, the reactor containing a catalyst configured to catalyze a reaction between oxygen and hydrogen and configured to produce an effluent stream comprising water;
a separation zone, the separation zone comprising a plurality of vessels containing an adsorbent configured to adsorb water, the separation zone configured to provide a purified product stream, the purified product stream comprising oxygen or hydrogen; and
a line configured to pass a recycled stream to the reactor to reduce an exotherm of the reactor, wherein the recycled stream comprises a portion of the effluent stream or a portion of the purified product stream.

20. The apparatus of claim 19 further comprising:
a water removal zone disposed upstream of the separation zone and configured to cool the effluent stream in the water removal zone to separate water and provide a water depleted effluent stream.
